(19) United States
(12) Patent Application Publication
(10) Pub. No.: US 2017/0293698 A1
(43) Pub. Date: Oct. 12, 2017

(54) EXPLORING A TOPIC FOR DISCUSSION THROUGH CONTROLLED NAVIGATION OF A KNOWLEDGE GRAPH

(71) Applicant: International Business Machines Corporation, Armonk, NY (US)

(72) Inventors: Ermyas Abebe, Victoria (AU); Kent C. Barton Steer, Victoria (AU); Andrew Lawrence Frenkiel, Yorktown Heights, NY (US); Dileban Karunamoorthy, Victoria (AU)

(21) Appl. No.: 15/096,784

(22) Filed: Apr. 12, 2016

(51) Int. Cl. G06F 17/30; G06F 3/0481

(52) U.S. Cl. CPC G06F 17/30958; G06F 3/0481; G06F 17/3053; G06F 17/30554

(57) ABSTRACT

Embodiments include method, systems and computer program products for exploring a topic through controlled navigation of a knowledge graph. Aspects include receiving, from a user of a user device, a topic; obtaining a knowledge graph based upon the topic, wherein the knowledge graph comprises a plurality of topic nodes, wherein each of the topic nodes comprises a weight; receiving a total time period for review of the topic; generating a candidate path through the knowledge graph, wherein the candidate path comprises a current topic node and a next topic node selected from the plurality of topic nodes; generating a time period for each of the plurality of topic nodes along the candidate path based upon the weight of the topic node and the total time period; and presenting the next topic node along the candidate path after an expiration of the time period associated with the current topic node.

### BACKGROUND

The present disclosure relates to topic or problem exploration, and more specifically, to methods, systems, and computer program products for exploring a topic or problem through controlled navigation of a knowledge graph.

One of the challenges of exploring an unfamiliar topic is knowing where to start, finding out the relevant sub-topics of the unfamiliar topic, and progressing with the discussion methodically with an objective in mind.

Such an exploration, for the purposes of learning or solving a problem, either individually or as a group, can benefit from the presence of a mentor or expert in the domain. In addition to helping participants understand various subtopics of the major topic, such guidance also includes the introduction of relevant subtopics and facts at appropriate times in order to pace the discussion in a meaningful order within a time-frame set by the individual or group.

In the absence of such an expert, the individual or group may find it hard to progress through the sub-topics, which can lead to them spending more time than necessary on areas that are less significant to the overall objective of the session. This can result in the overall problem not being adequately or methodically explored within the given time.

### SUMMARY

Embodiments include a computer system for exploring a topic or problem through controlled navigation of a knowledge graph, the computer system including a processor, the processor configured to perform a method. The method includes obtaining a knowledge graph based upon a topic, wherein the knowledge graph comprises a plurality of topic nodes, wherein each of the plurality of topic nodes comprises a weight; receiving a total time period for review of the topic; generating a candidate path through the knowledge graph, wherein the candidate path comprises at least a current topic node and a next topic node selected from the plurality of topic nodes; generating a time period for each of the plurality of topic nodes along the candidate path based upon the weight of the topic node and the total time period; and presenting the next topic node along the candidate path after an expiration of the time period associated with the current topic node.

Embodiments also include a computer program product exploring a topic or problem through controlled navigation of a knowledge graph, the computer program product including a non-transitory computer readable storage medium having computer readable program code embodied therewith. The computer readable program code including computer readable program code configured to perform a method. The method includes obtaining a knowledge graph based upon a topic, wherein the knowledge graph comprises a plurality of topic nodes, wherein each of the plurality of topic nodes comprises a weight; receiving a total time period for review of the topic; generating a candidate path through the knowledge graph, wherein the candidate path comprises at least a current topic node and a next topic node selected from the plurality of topic nodes; generating a time period for each of the plurality of topic nodes along the candidate path based upon the weight of the topic node and the total time period; and presenting the next topic node along the candidate path after an expiration of the time period associated with the current topic node.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates a block diagram of a computer system for use in practicing the teachings herein;

FIG. 2 illustrates a block diagram of a system for exploring a topic for a discussion through controlled navigation of a knowledge graph in accordance with an embodiment;

FIG. 3 illustrates a flow diagram of a method for exploring a topic for a discussion through controlled navigation of a knowledge graph in accordance with an embodiment;

FIG. 4 illustrates a flow diagram of a method for exploring a topic for a discussion through controlled navigation of a knowledge graph in accordance with an embodiment; and

FIGS. 5A, 5B and 5C illustrate block diagrams of knowledge graphs in according with an embodiment.

### DETAILED DESCRIPTION

In accordance with exemplary embodiments of the disclosure, methods, systems and computer program products exploring a topic or problem through controlled navigation of a knowledge graph are provided.

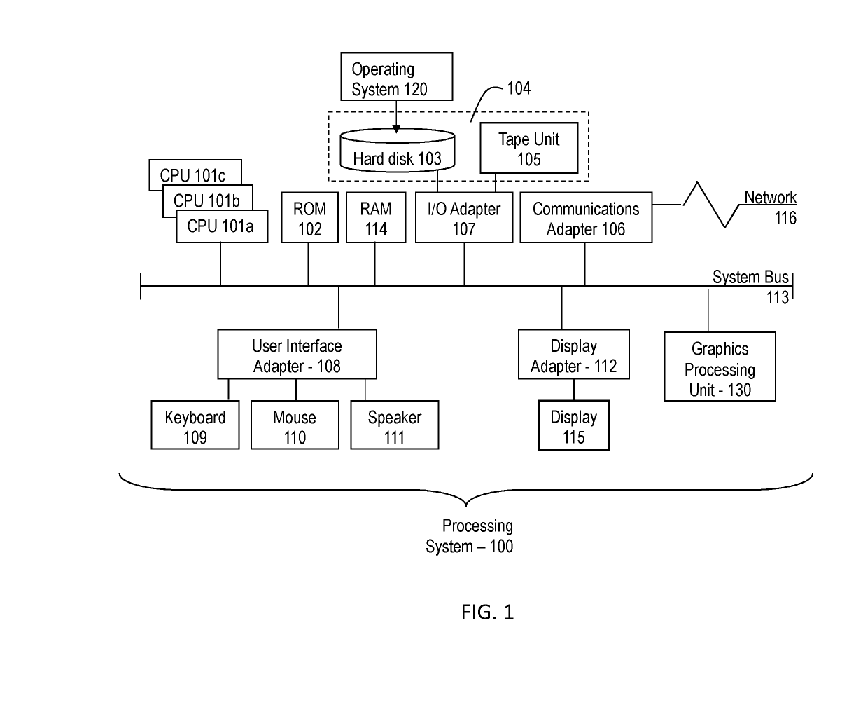

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 1.

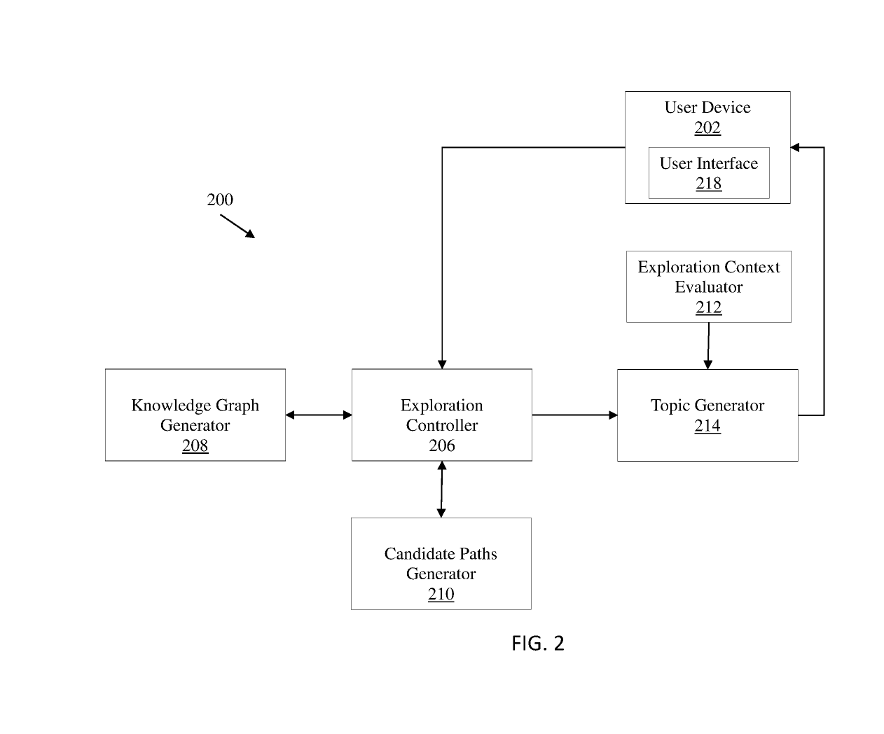

FIG. 2 is a block diagram illustrating a system 200 for exploring a topic or problem through controlled navigation of a knowledge graph according to an embodiment. As shown in FIG. 2, the system 200 includes a user device 202 which can include a personal computer (PC), laptop computer, smart phone, personal digital assistant (PDA) device, tablet, or any suitable processing device such as the one shown in FIG. 1. The user device 202, via a user interface 218, inputs topics or problems and goals into the system 200 according to exemplary embodiments. The system 200 also includes an exploration controller 206 which extracts the topic or problem and goal from the input from the user device 202. In exemplary embodiments, this extracted information can be used by the exploration controller to obtain a knowledge graph. The knowledge graph can be obtained by searching on an existing knowledge graph or by generating a new knowledge graph. In one example, an exploration controller 206 that is presented with the same or similar topic or problem and may utilize a knowledge graph from that previously presented topic for use in the system 200. In exemplary embodiments, the exploration controller 206 can be implemented on the processing system 100 found in FIG. 1. The system 200 also includes a knowledge graph generator 208 which generates a new weighted knowledge graph from an existing knowledge corpus. The knowledge graph generator 208 can also extract a slice from an existing larger graph that is sufficient to represent a topic or problem and goal. The knowledge graph generator 208 can be implemented on the processing system 100 found in FIG. 1.

The system 200 also includes a candidate paths generator 210 which searches the weighted knowledge graph from a topic or problem node to a suitable goal node generating one or more candidate paths along the knowledge graph. The candidate path generator 210 utilizes graph search techniques according to acceptable best practices for searching knowledge graphs according to an exemplary embodiment. In exemplary embodiments, for each of the nodes on each of the candidate paths generated by the candidate path generator 210, the system 200 generates a time frame, wherein the time frame represents the overall time allocated for a session for a given candidate path. The time frame could be based upon the weight of a node in the candidate path along the knowledge graph relative to all the weights of the nodes within the candidate path. For example, if a node has a small weight for topic exploration, the time frame will be smaller than a node that has a greater weight for topic exploration. The system 200 includes a topic generator 214 which generates a sequence of topics based upon one of the candidate paths, according to an exemplary embodiment. The system 200 also includes an exploration context evaluator 212 which tracks the current location of an individual or group along the candidate path. The candidate path generator 210, the topic generator 214, and the exploration context evaluator 212 can be implemented on the processing system 100 as shown in FIG. 1.

In exemplary embodiments, a user of the user device 202 containing a user interface 218 which a user inputs a topic or problem and goal into the system 200. The user device 202 may be a touch screen device such as a smart phone or tablet. The topic or problem and goal may be received by the exploration controller 206 which uses the input information to formulate a search. The knowledge graph generator 208 generates a new knowledge graph or pulls from an existing knowledge graph and present this knowledge graph to the exploration controller 206. The candidate paths generator 210 generates one or more candidate paths to reach a suitable goal. In exemplary embodiments, a suitable goal may be a complete exploration and discussion of the topic and any subtopics related to the topic. The topic generator 214 receives the one or more candidate path and generates a sequence of topics based upon this candidate path or paths. The candidate path includes topic or problem nodes wherein each node in the candidate path may represent a possible sub-topic.

In exemplary embodiments, the sub-topics can be assigned a time period for exploration by the candidate paths generator 210. The topic generator may be configured to introduce new sub-topics from the sequence of topics within the candidate path or paths when the time-frame for the sub-topic has elapsed. The user of the user device 202 may be presented with the option of requesting the next sub-topic in the sequence if the user is familiar with the current sub-topic. The user may also request, via the user device 202, the topic generator 214 to show alternative sub-topics which may generate from a parent topic node to continue further exploration. The candidate paths generator 210 is configured to calculate new paths and time periods from the current topic or sub-topic node as exploration advances. The exploration context evaluator 212 may track the location of the user within a candidate path. Should the user's location along the candidate path deviate by a configurable distance d from any one of the candidate paths, the topic generator 214 is notified by the exploration context evaluator 212 to either re-introduce the current sub-topic or introduce the next sub-topic in the sequence based on the time-frame allocated to the current sub-topic.

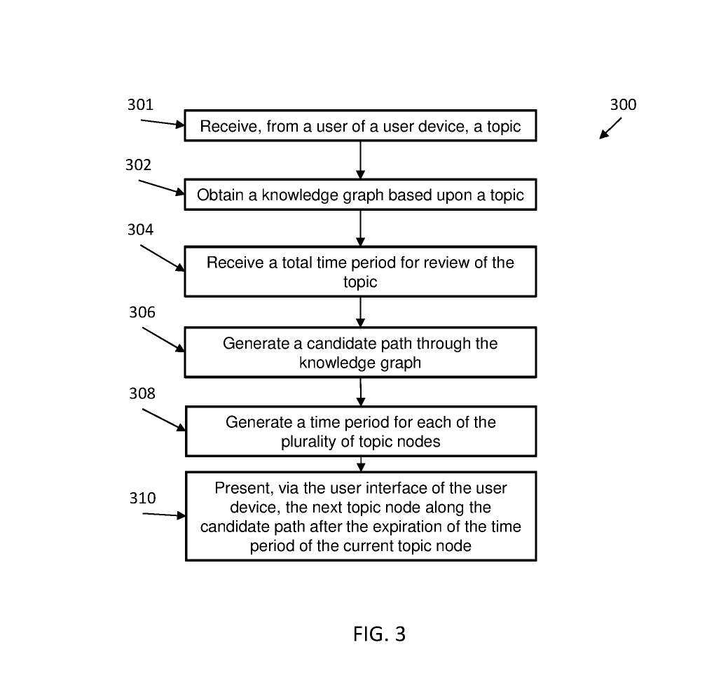

Referring now to FIG. 3, a flow diagram of a method 300 for exploring a topic for discussion through controlled navigation of a knowledge graph according to an embodiment. As shown in block 301, the method includes receiving, from a user of a user device, a topic for exploration. As shown at block 302, the method also includes obtaining a knowledge graph based upon a topic for discussion. In one embodiment, the knowledge graph is obtained via generating a new knowledge graph from an existing knowledge body. In another embodiment, the knowledge graph is obtained by extracting a knowledge graph from existing knowledge graphs or utilizing a knowledge graph previously generated based upon a topic for discussing. The method 300 also includes receiving a total time period for review of the topic, as shown in block 304. In exemplary embodiments, this time period can be based on a profile of a member of the topic discussion or other preference information. For example, a user's profile can have a link to the user's calendar which would indicate time slots available with time constraints that would determine the time period available for discussion of the topic. Also, any other participants can link their calendar to the profile to determine a time period for discussion that is feasible for all participants. Additionally, a user's profile can indicate a time limit for topic discussion meetings.

Next, as shown in block 306, the method 300 generates a candidate path through the obtained knowledge graph. The method 300 also includes generating a time period of the plurality of topic nodes along the candidate path, as shown at block 308. In exemplary embodiments, the time periods for the topic nodes are based on the weight of the topic node as well as the total time period for review of the topic of discussion. Next, as shown in block 310, the method 300 presents, via the user interface of the user device, the next topic node along the candidate path after the expiration of the time period of the current node.

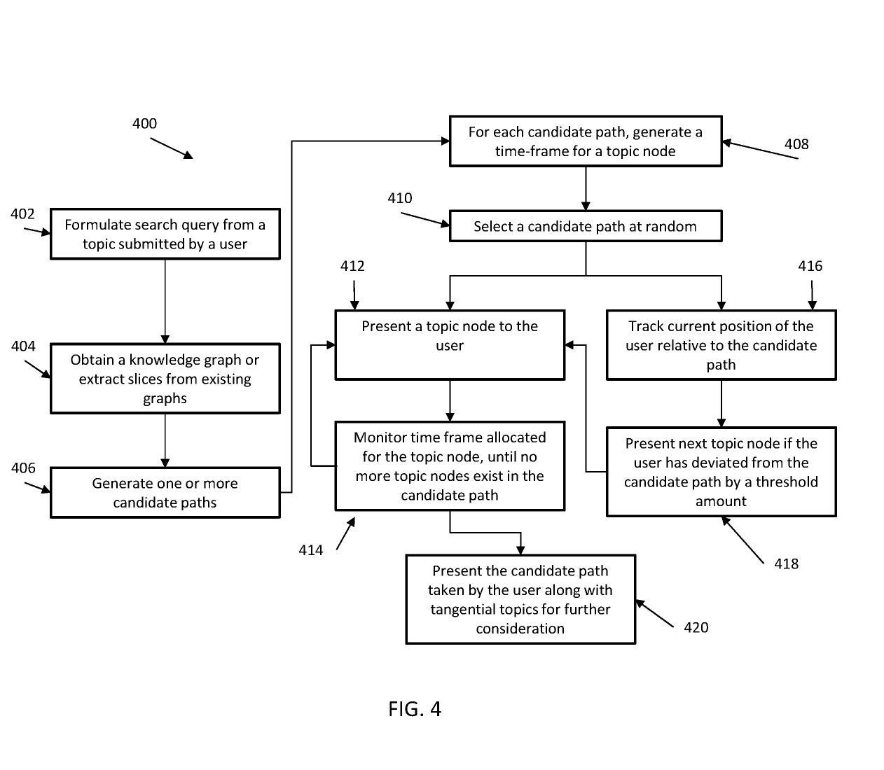

Referring now to FIG. 4, a flow diagram of a method 400 for exploring a topic for a discussion through controlled navigation of a knowledge graph according to an embodiment is shown. The method 400 includes formulating a search query from a topic for discussion submitted by a user, as shown at block 402. This search query looks for existing knowledge graphs within a body of knowledge graphs that relate to the topic for discussion. The user submitted topic of discussion can be parsed to extract the relevant topics to assist in obtaining a relevant knowledge graph. The user submitted topic for discussion may be entered in a free text or a Boolean search format. This submitted format is parsed to extract the relevant information and eliminate any extraneous information. Next, as shown in block 404, the method 400 obtains a knowledge graph or extracts slices from existing knowledge graphs. The method 400 includes generating one or more candidate paths as shown in block 406. Next, at block 408, the method 400 generates a time frame for each of the topic nodes along each of the one or more candidate paths. In exemplary embodiments, the time frame for each topic node is based on the weight of the topic node. Next, as shown at block 410, a candidate path is selected at random. In exemplary embodiments, the candidate path may be selected by the user or selected by the system based upon weighted values of the topic nodes along the candidate path.

The method 400 also includes presenting a topic node to the user, as shown at block 412. In exemplary embodiments, the topic node presented is the next topic node within the candidate path of the knowledge graph. Additionally, at block 416, the method 400 tracks the current position of the user relative to the candidate path. And at block 418, the method 400 presents the next topic node within the candidate path if the user has deviated from the candidate path by a threshold amount. A threshold amount may be a distance from the topic node. The threshold amount may be determined by a user input showing a user selection of a topic node outside the candidate path. For example, a user may choose a topic node that is tertiary to a topic node within the candidate path for exploration or discussion. If this tertiary topic node strays further than the threshold distance from the topic node, the method 400 will present the next topic node to the user to ensure the user remains on the candidate path. Additionally, at block 414, the method 400 monitors the time frame allocated for the topic node, until not more topic nodes exist in the candidate path. If the topic node time frame expires, the user is presented with the next topic node as shown at block 412. Next, at block 420, after completion of the candidate path, the user is presented with the candidate path taken along with tangential topics for further consideration.

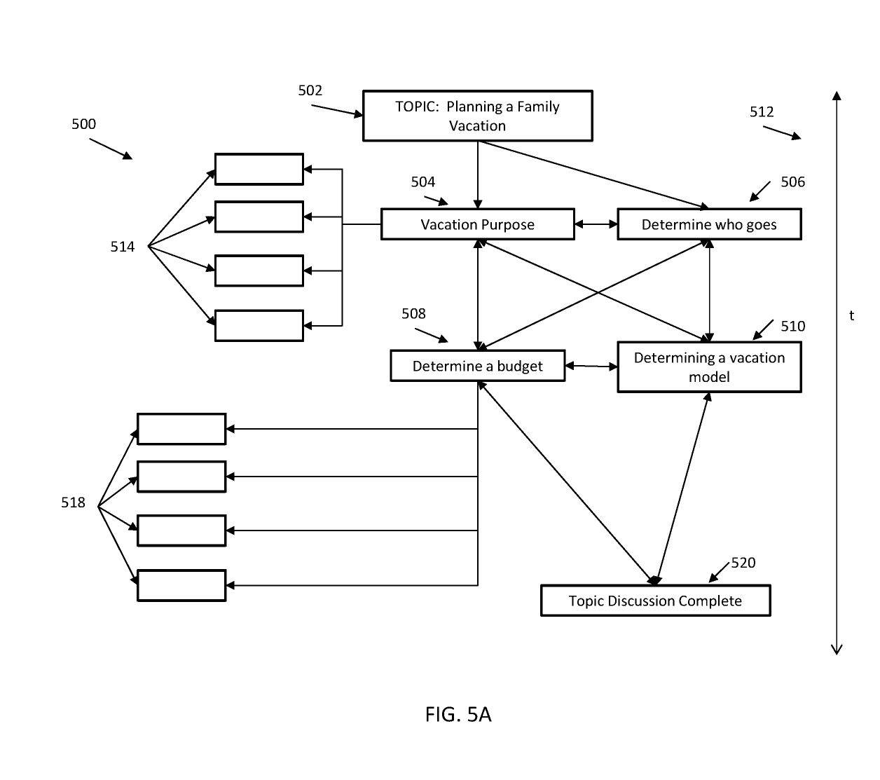

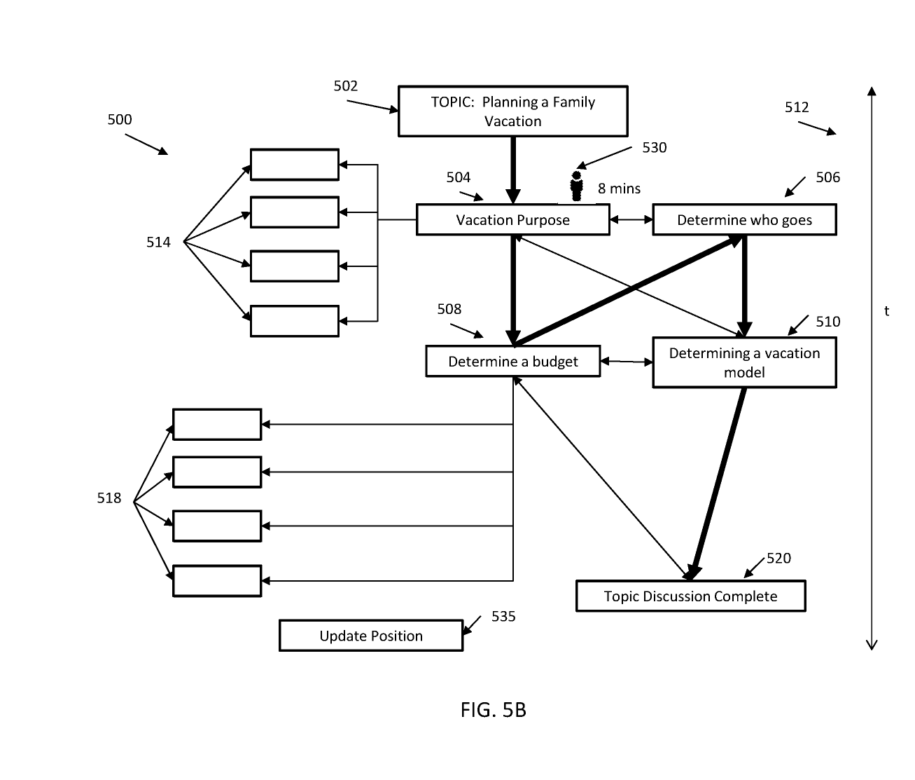

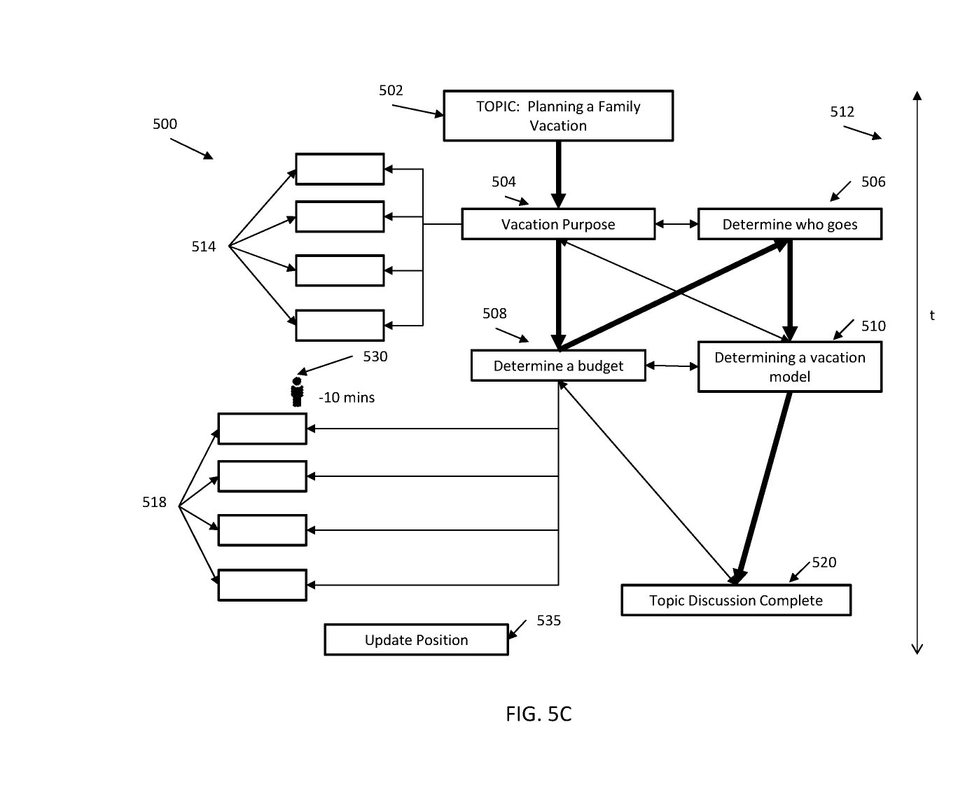

FIG. 5A is a block diagram of a knowledge graph 500 for exploring a topic of discussion according to an embodiment. Within the knowledge graph 500, the topic of discussion is “Planning a Family Vacation,” as shown at block 502. The topic is entered by the user of the system for further exploration of the topic. The topic may be parsed to extract the relevant portion of the discussion topic. For example, “planning a family vacation” may parse out the “a” and focus more on “vacation” and “family” as well as “plan” or “planning” according to an embodiment. After parsing, a query is submitted to obtain a knowledge graph. A knowledge graph is obtained by creating a new knowledge graph from a knowledge corpus, extracting a slice of a knowledge graph from an existing knowledge graph, or utilizing a previously created knowledge graph for the same or similar topic. The total time for discussion of this topic 512 is received either through an input from the user or generated from a user profile, a user selection of the time period or historical information for the topic. For example, in previous iterations of this topic, the total time 512 for discussion has averaged one hour which can be used to determine a total time per this historical information for the topic. Next, in the knowledge graph 500, a candidate path is generated which shows a path containing topic nodes that will be traversed, shown at block 504, 506, 508, and 510. Weights are assigned to each of the topic nodes to determine a time period for each topic node along the candidate path based on the weight and the total time available for the user to explore the topic of discussion. The time period for each topic node may be based on a profile of the user, a user selection of the time period, and historical information of the topic node for discussion. In an embodiment, the weights may be pre-configured or extracted from reference information, such as the prominence in linked data sources. These weights are normalized based upon the number of topic nodes along the candidate path as it relates to the total time available 512.

FIG. 5B is a block diagram of an exemplary embodiment for exploring a topic or problem through controlled navigation of a knowledge graph. The knowledge graph 500 is presented to the user with the candidate path topic nodes (504, 506, 508, 510) highlighted for the user to select. Highlighting of the topic nodes along the candidate path can be shown as brighter than the surrounding nodes or can have arrow paths that are more pronounced (as shown in FIG. 5B) or any other visual feature that allows the candidate path to stand out from the other nodes of the knowledge graph. In exemplary embodiments, the knowledge graph is presented via a user interface on a touch screen device, such as a tablet. The user of the touch screen device navigates the knowledge graph via the highlighted candidate path. Topic nodes that are not along the candidate path, shown at block 514 and 518, are not highlighted. These non-highlighted topic nodes 514, 518 are digressions within the knowledge graph. The user's position within the knowledge graph 500 is tracked as the user traverses the topic nodes. The user's position is indicated by an icon 530 that also displays the remaining time period for the discussion shown on the user interface. As shown in FIG. 5B, the icon 530 displays a time remaining of 8 minutes for the current topic node of “Vacation Purpose” 504. In an embodiment, the knowledge graph is displayed via a user interface 218 on a user device 202. The user device 202 may be a touch screen device such as a smart phone or tablet which displays via the user interface 218 the knowledge graph 500 and the candidate paths. As a user traverses the candidate path, the user may touch the screen of the user device 202 to indicate a progression through to a specific node of the candidate path. In instances where the user has not utilized the full amount of allotted time for a topic node, the user may touch the “Update Position” 535 button to move the icon 530 to the next topic node and to recalculate the remaining time. The user may explore the various topic nodes in the knowledge graph 500 through the touch screen device by touching the nodes on the user interface. The icon 535 will reposition either through touching the update position button 535 or automatically. The icon 535 can also indicate to the user if time is running out for a topic node on the candidate path or if the user is exploring topic nodes that deviate from the candidate path by a threshold.

FIG. 5C is a block diagram of an exemplary embodiment for exploring a topic or problem through controlled navigation of a knowledge graph. As shown in FIG. 5C, a user may select digressions 514, 518, which moves the icon 530 away from the candidate path. If the user moves to a digression 518 topic node beyond a threshold amount, the user is presented with topic nodes along the candidate path (504, 506, 508, 510) to resume discussion. These topic nodes may be highlighted or may begin flashing so the user knows to select the topic node along the candidate path. Additionally, the icon 530 may begin flashing or playing a sound via the user device 202 to guide the user back to the candidate path. Digression topic nodes 514 that are not beyond a threshold amount may be explored by the user, however, the total time period constraint would still govern this exploration and the user may be presented with topic nodes along the candidate path (504, 506, 508, 510) should the user linger on digression topic nodes 514. When a user runs out of topic nodes along the candidate path, the topic discussion is complete as shown at block 520. In an embodiment, the icon 530 is configured to indicate a negative time amount for the user when the user is exploring a digression topic node 518, 514. As the total time for exploration begins to run out, the icon 530 along with the nodes along the candidate path (504, 506, 508, 510) may begin to flash, play an audio signal, or become larger to indicate the user to return to the topic nodes on the candidate path.

In exemplary embodiments, as a user traverses a candidate path of a knowledge graph and the user's progression is tracked. If the user remains on a topic node beyond the allocated time period, the user is notified that the time period has expired and the user is presented with one or more topic nodes to progress the user through the candidate path. The user may be notified of a time remaining for a given topic node based upon an elapsed time relative to a start time of discussion of a selected topic node. The time remaining may be any of a five, ten, or one minute remaining warning or the like. In an embodiment, the tracking of the user's progress through the knowledge graph can be based on a user input. For example, if a user finishes discussion of a topic node before the allocated time period, the user may input that the user has completed the discussion on this topic node via an input on the user device. Additionally, the remaining total time is recalculated and the remaining topic nodes are reallocated additional time for time periods. The same is true should go over the allotted time period for a topic node.

In exemplary embodiments, after the knowledge graph for a topic for discussion is obtained, the user may customize the knowledge graph by adding or removing topic nodes and adjusting the weights of the topic nodes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for exploring a topic for a discussion through controlled navigation of a knowledge graph, the method comprising:
receiving, from a user of a user device, a topic;
obtaining a knowledge graph based upon the topic, wherein the knowledge graph comprises a plurality of topic nodes, wherein each of the plurality of topic nodes comprises a weight;
receiving a total time period for review of the topic;
generating a candidate path through the knowledge graph, wherein the candidate path comprises at least a current topic node and a next topic node selected from the plurality of topic nodes;
generating a time period for each of the plurality of topic nodes along the candidate path based upon the weight of the topic node and the total time period; and
presenting, via a user interface of the user device, the next topic node along the candidate path after an expiration of the time period associated with the current topic node.

2. The method according to claim 1, wherein the user device is one of a smart phone, a computer, and a tablet.

3. The method according to claim 2, further comprising:
monitoring a progress through the candidate path of the knowledge graph;
determining a current position in the candidate path; and
presenting to the user the next topic node along the candidate path based upon a determination that the user has deviated from the candidate path by a threshold amount.

4. The method according to claim 3, further comprising:
recalculating the time period for the plurality of nodes based upon a user transitioning to the next topic before the time period has expired for the current topic node; and
recalculating the time period for the plurality of nodes based upon a user transitioning to the next topic after the time period for the current topic node has expired.

5. The method according to claim 4, wherein the user transitioning to the next topic is determined by a user input.

6. The method according to claim 1, wherein the knowledge graph is obtained from an extracted slice of an existing knowledge graph.

7. The method according to claim 1, wherein the plurality of topic nodes are weighted according to one of a pre-configured value, a value derived from reference information of the topic node, and a value normalized to a number of sub-topics on the candidate path.

8. The method according to claim 2, wherein the time period is based upon one of a profile of a user, a user selection of the time period, and a historical information for the topic.

9. The method according to claim 2, further comprising:
notifying the user of a remaining time for the current topic node based upon an elapsed time from a start of the current topic node and the time period.

10. A system for exploring a topic for discussion through controlled navigation of a knowledge graph, the system comprising:
a processor configured to:
receive, from a user of a user device, a topic;
obtain a knowledge graph based upon the topic, wherein the knowledge graph comprises a plurality of topic nodes, wherein each of the plurality of topic nodes comprises a weight;
receive a total time period for review of the topic;
generate a candidate path through the knowledge graph, wherein the candidate path comprises at least a current topic node and a next topic node selected from the plurality of topic nodes;
generate a time period for each of the plurality of topic nodes along the candidate path based upon the weight of the topic node and the total time period; and
present, via a user interface of the user device, the next topic node along the candidate path after an expiration of the time period associated with the current topic node.

11. The system according to claim 10, wherein the user device is one of a smart phone, a computer and a tablet.

12. The system according to claim 11, further comprising:
the processor configured to:
monitor a progress through the candidate path of the knowledge graph;
determine a current position in the candidate path; and
present to the user the next topic node along the candidate path based upon a determination that the user has deviated from the candidate path by a threshold amount.

13. The system according to claim 12, further comprising:
the processor configured to:
recalculating the time period for the plurality of nodes based upon a user transitioning to the next topic before the time period has expired for the current topic node; and
recalculating the time period for the plurality of nodes based upon a user transitioning to the next topic after the time period has expired for the current topic node.

14. The system according to claim 13, wherein the user transitioning to the next topic is determined by a user input.

15. The system according to claim 10, wherein the knowledge graph is obtained from an extracted slice of an existing knowledge graph.

16. The system according to claim 11, further comprising:
the processor configured to:
notify the user of a remaining time for the current topic node based upon an elapsed time from a start of the current topic node and the time period.

17. A computer program product for proximity based content security, the computer program product comprising:
a tangible storage medium readable by a processing circuit and storing instructions for execution by the processing circuit for performing a method comprising:
receiving, from a user of a user device, a topic;
obtaining a knowledge graph based upon the topic, wherein the knowledge graph comprises a plurality of topic nodes, wherein each of the plurality of topic nodes comprises a weight;
receiving a total time period for review of the topic;
generating a candidate path through the knowledge graph, wherein the candidate path comprises at least a current topic node and a next topic node selected from the plurality of topic nodes;
generating a time period for each of the plurality of topic nodes along the candidate path based upon the weight of the topic node and the total time period; and
presenting, via a user interface of the user device, the next topic node along the candidate path after an expiration of the time period associated with the current topic node.

18. The computer program product according to claim 17, wherein the user device is one of a smart phone, a computer, and a tablet.

19. The computer program product according to claim 18, further comprising:
monitoring a progress through the candidate path of the knowledge graph;
determining a current position in the candidate path; and
presenting to the user the next topic node along the candidate path based upon a determination that the user has deviated from the candidate path by a threshold amount.

20. The computer program product according to claim 19, further comprising:
recalculating the time period for the plurality of nodes based upon a user transitioning to the next topic before the time period has expired for the current topic node; and
recalculating the time period for the plurality of nodes based upon a user transitioning to the next topic after the time period has expired for the current topic node.
